(19) United States
(12) Patent Application Publication
(10) Pub. No.: US 2026/0136126 A1
(43) Pub. Date: May 14, 2026

(54) TUNING HEADSET BODY AND A HEADSET

(71) Applicant: Haixiang Zhai, Shenzhen (CN)

(72) Inventor: Haixiang Zhai, Shenzhen (CN)

(21) Appl. No.: 19/032,135

(22) Filed: Jan. 20, 2025

(30) Foreign Application Priority Data
Nov. 6, 2024 (CN) 2024115775571

(51) Int. Cl. H04R 1/10; H04R 1/28

(52) U.S. Cl. CPC H04R 1/1041; H04R 1/1008; H04R 1/1075; H04R 1/2811; H04R 2400/11

(57) ABSTRACT

A tuning headset body and a headset are provided. The tuning headset body includes a front housing, a rear housing, a sounding unit, a suspension frame and a tuning assembly, where the rear housing is positioned opposite the front housing; the sounding unit is arranged between the front housing and the rear housing; the suspension frame is arranged between the front housing and the rear housing, the sounding unit is mounted on the suspension frame, the suspension frame divides an internal space of the tuning headset body into a tuning cavity and a rear sound cavity, a sound-transmitting channel is defined on the suspension frame to communicate the tuning cavity with the rear sound cavity; and the tuning assembly is configured to control a degree of closure of the sound-transmitting channel to adjust air flow resistance at a corresponding position.

### CROSS REFERENCE TO RELATED APPLICATIONS

This application claims foreign priority of Chinese Patent Application No. 202411577557.1, filed on Nov. 6, 2024 in the China National Intellectual Property Administration, the disclosures of all of which are hereby incorporated by reference.

### TECHNICAL FIELD

The present disclosure relates to the technical field of listening device, in particular to a tuning headset body and a headset.

### BACKGROUND

Headset is commonly used as a common audio playback device, a sound transmission channel formed by a structure and position relationship of an internal shell, a sounding unit determines the characteristics of output audio. However, a structural design of existing headsets, even professional headsets that pursue an ultimate sound quality, often places emphasis on a frequency response in order to adapt to a specific music type or a use scenario. This leads to existence of headsets with a too heavy low frequency, a poor high frequency response, large granular sensation, a sharp sound, poor sound field performance, three frequency imbalance of an intermediate frequency, a high frequency and a low frequency, affecting sound quality performance.

In order to solve the above problems, there are currently tuning headsets on the market, but the current tuning headsets usually use electrical tuning, in actual use of users, it is found that the use of the electrical tuning often loses acoustic performance.

### SUMMARY

To solve the above technical problems, this application provides a tuning headset body, including: a front housing, a rear housing, a sounding unit, a suspension frame and a tuning assembly; wherein, the rear housing is positioned opposite the front housing; and the sounding unit is arranged between the front housing and the rear housing; and the suspension frame is arranged between the front housing and the rear housing; and
the sounding unit is mounted on the suspension frame; wherein an internal space of the tuning headset body is divided into a tuning cavity and a rear sound cavity by the suspension frame; the tuning cavity includes a front sound cavity and a tuning diaphragm cavity; and a sound-transmitting channel is defined on the suspension frame to communicate the tuning cavity with the rear sound cavity; and the tuning assembly is configured to control a degree of closure of the sound-transmitting channel to adjust air flow resistance.

Furthermore, the sound-transmitting channel includes a third sound-transmitting hole, a tuning channel is defined in the rear sound cavity of the rear housing, and the tuning channel is communicated with the third sound-transmitting hole; and the tuning assembly includes a tuning valve, the tuning valve is arranged in the tuning channel, and the tuning valve is configured to control a degree of closure of the third sound-transmitting hole, and to adjust air flow resistance.

Furthermore, the suspension frame includes a main suspension frame and a transducer suspension frame; and the sound-transmitting channel includes first sound-transmitting holes andsecond sound-transmitting holes; wherein the first sound-transmitting holes are arranged in the main suspension frame and arranged coaxially at intervals; and the second sound-transmitting holes are arranged in the transducer suspension frame and arranged coaxially at intervals; and wherein the first sound-transmitting holes and the second sound-transmitting holes are communicated with the tuning cavity and the rear sound cavity; and the tuning assembly is configured to adjust degrees of closure the first sound-transmitting hole and the second sound-transmitting hole.

Furthermore, the suspension frame includes a transducer suspension frame;
wherein the sound-transmitting channel further includes second sound-transmitting holes and a third second sound-transmitting hole; wherein the second sound-transmitting holes are arranged in the transducer suspension frame and arranged coaxially at intervals; and the third second sound-transmitting hole is defined on a center of the transducer suspension frame; wherein the second sound-transmitting holes and the third sound-transmitting hole are communicated with the tuning cavity and the rear sound cavity; and the tuning assembly is further configured to adjust to adjust degrees of closure the second sound-transmitting holes and the third sound-transmitting hole.

Furthermore, the tuning assembly includes a second valve plate, the second valve plate is rotationally provided on the suspension frame to control degree of closure of the second sound-transmitting holes.

Furthermore, the second valve plate includes a baffle plate and an adjusting part; wherein the baffle plate is defined with through holes, and positions of the through holes are corresponded to positions of the second sound-transmitting holes to rotate the baffle plate and control the degree of closure of the second sound-transmitting holes; and

the adjusting part is connected to the baffle plate, and at least partially of the adjusting part is exposed outside the suspension frame.

Furthermore, wherein the suspension frame includes a main suspension frame; wherein the sound-transmitting channel further includes a plurality of first sound-transmitting holes; wherein the first sound-transmitting holes are arranged in the main suspension frame and arranged coaxially at intervals; and wherein the first sound-transmitting holes are communicated with the tuning cavity and the rear sound cavity; and the tuning assembly is further configured to adjust degree of closure the first sound-transmitting holes.

Furthermore, the tuning assembly includes a first valve plate, the first valve plate is rotationally provided on the main suspension frame, to control degree of closure of the first sound-transmitting holes.

Furthermore, the tuning assembly further includes a tuning value; and the tuning channel is defined on the rear sound cavity of the rear housing; and the tuning value is communicated to at least one of the third sound-transmitting hole; the tuning value is located in the tuning channel, and the tuning value is configured to control degree of closure of the third sound-transmitting holes, to adjust corresponding air flow resistance.

Furthermore, the tuning valve is defined with a hollow portion, and the tuning valve is configured to control a position of the hollow portion by moving relative to the rear housing, further to control the degree of closure of the third sound-transmitting hole.

Furthermore, a matching part is defined on the rear housing to match with the hollow portion, and the tuning valve is rotationally connected to the rear housing, the tuning valve is configured to adjust an overlap degree between the hollow portion and the matching part, so as to control the degree of closure of the third sound-transmitting hole.

Furthermore, the hollow portion is located on a side of the tuning valve close to the sounding unit; and the matching part is arranged on a side of the rear housing close to the sounding unit, to connect the tuning channel and the rear sound cavity.

Furthermore, the tuning valve is penetrated through by the hollow portion, and the rear housing is penetrated through by the matching part; and when the overlap degree between the matching part and the hollow portion increases, the air flow resistance of the hollow portion becomes smaller.

Furthermore, the tuning valve is slidably connected to the rear housing, and the hollow portion is located in the tuning channel and adjacent to the third sound-transmitting hole.

Furthermore, tuning damping pieces are uniformly set in the sound-transmitting channel or the tuning assembly of the suspension frame.

Furthermore, the sounding unit includes a transducing assembly and a diaphragm, the diaphragm is fixedly connected to a side of the suspension frame away from the rear housing; wherein the tuning diaphragm cavity includes a first tuning diaphragm cavity and a second tuning diaphragm cavity; the first tuning diaphragm cavity is arranged along an outer perimeter of the suspension frame; and a center of the second tuning diaphragm cavity is located on the suspension frame.

Furthermore, the transducing assembly is one or more of a coil, a magnet, a piezoelectric element and an electrostatic element.

The present disclosure also provides a headset, wherein including a headset beam and a tuning headset body mentioned above, the headset beam is connected to the tuning headset body.

The present disclosure disclosed a tuning headset body and a headset, the tuning headset body includes a front housing, a rear housing, a sounding unit, a suspension frame and a tuning assembly, where the rear housing is arranged on one side of the front housing; the sounding unit is arranged between the front housing and the rear housing; the suspension frame is arranged between the front housing and the rear housing, the sounding unit is mounted on the suspension frame, the suspension frame divides an internal space of the tuning headset body into a tuning cavity and a rear sound cavity, the tuning cavity includes a front sound cavity and a tuning diaphragm cavity; and the suspension frame is provided with a sound-transmitting channel to communicate the tuning cavity with the rear sound cavity; and the tuning assembly is configured to control a degree of closure of the sound-transmitting channel. The tuning headset body is provided with the sound-transmitting channel between the tuning cavity and the rear sound cavity. The degree of closure of the sound-transmitting channel is controlled by the tuning assembly, and then the air flow resistance between the front and rear sound cavities and the external environment is adjusted. A sound field, frequency response range, high, middle and low frequency bands, timbre and sound insulation effect are effectively adjusted by physical means, so as to expand the headset body to adapt to a listening sound type and a use scenario

### BRIEF DESCRIPTION OF THE DRAWINGS

In order to descirbe the technical schemes in the embodiments of the present disclosure or the prior art more clearly, the following is a brief introduction of drawings required to be used in the description of the embodiments or the prior arts. Obviously, the drawings described below are only some embodiments of the present disclosure. For ordinary technicians in the field, without creative labor, other drawings can also be obtained from these drawings.

FIG. 1 is a section schematic diagram of a tuning headset body according to an embodiment of the present disclosure.

FIG. 2 is a first exploded diagram of the tuning headset body according to an embodiment of the present disclosure.

FIG. 3 is a second exploded diagram of the tuning headset body according to an embodiment of the present disclosure.

FIG. 4 is a schematic structural diagram of a rear housing and a tuning valve according to an embodiment of the present disclosure.

FIG. 5 is a schematic structural diagram of the rear housing and the tuning valve in FIG. 4 from another view.

FIG. 6 is a third exploded diagram of the tuning headset body according to an embodiment of the present disclosure.

FIG. 7 is a fourth exploded diagram of the tuning headset body according to an embodiment of the present disclosure.

FIG. 8 is a schematic structural diagram of a rear housing and a tuning valve according to another embodiment of the present disclosure.

FIG. 9 is a schematic structural diagram of the rear housing and the tuning valve in FIG. 8 from another view.

FIG. 10 is a schematic structural diagram of a headset according to another embodiment of the present disclosure.

FIG. 11 a schematic structural diagram of a rear housing and a tuning valve in FIG. 8.

FIG. 12 is a schematic structural diagram of a suspension frame, a valve plate and a bass rotary knob of the tuning headset body according to another embodiment of the present disclosure.

FIG. 13 is a schematic structural diagram of the tuning headset body of FIG. 12 with the valve plate locates in another position.

FIG. 14 is a schematic structural diagram of the tuning headset body of FIG. 12 with the valve plate locates in another position.

FIG. 15 is an exploded diagram of the headset according to an embodiment of the present disclosure.

FIG. 16 is a first diagram of frequency response curve graph.

FIG. 17 is a second diagram of frequency response curve graph.

FIG. 18 is a third diagram of frequency response curve graph.

FIG. 19 is a fourth diagram of frequency response curve graph.

FIG. 20 is a five diagram of frequency response curve graph.

FIG. 21 is a six diagram of frequency response curve graph.

### DESCRIPTION OF THE REFERENCE NUMERAL

1. front housing; 11. tuning cavity; 12. through hole area; 2. sounding unit; 21. transducing assembly; 22. diaphragm; 23. tuning diaphragm cavity; 231. first tuning diaphragm cavity; 232. second tuning diaphragm cavity; 3. suspension frame; 31. main suspension frame; 32. transducer suspension frame; 4. rear housing; 42. rear sound cavity; 43. matching part; 5. sound-transmitting channel; 51. first sound-transmitting hole; 52. second sound-transmitting hole; 53. third sound-transmitting hole; 6. tuning channel; 7. vibration sound guide gap; 8. tuning assembly; 81. first valve plate; 82. second value plate; 821. baffle plate; 8211. through hole; 822. adjusting part; 83. tuning valve; 821. hollow portion; 833. adjusting knob; 83 tuning value; 831. hollow portion; 833, adjusting knob; 9. tuning damping piece; 10. relief hole.

### DETAILED DESCRIPTION OF THE EMBODIMENTS

In the description of the present disclosure, it is to be understood that orientation or position relationships indicated by terms “up”, “down”, “front”, “back”, “left”, “right”, “vertical”, “horizontal”, “top”, “bottom”, “inside”, “outside”, “clockwise”, “counter-clockwise”, “axial” and so on are based on orientation or position relationships shown in the attached drawings. It is only for the purpose of facilitating the description of the present disclosure and simplifying the description, but not used to indicate or imply that a device or an element referred to must have a particular orientation, be constructed and operated in a particular orientation, and therefore cannot be construed as a limitation of the present disclosure. In addition, the terms “first” and “second” are used for description purpose only and are not to be understood as indicating or implying relative importance or as implicitly indicating a quantity of technical features indicated. Thus, a feature defined as “first” or “second” may explicitly or implicitly include at least one of the features. In the description of the present disclosure, “a plurality of” means at least two, such as two, three, unless otherwise expressly specified.

In the present disclosure, the terms “mount”, “connected”, “connect”, “fixedly connect”, etc. shall be understood broadly, unless otherwise expressly specified and limited. For example, it may be a fixed connection, a removable connection, or integrated; and it may be directly connected or indirectly connected through an intermediate medium, unless otherwise expressly specified. For ordinary technicians in the field, specific meaning of the above terms in the present disclosure can be understood according to specific circumstances.

In the present disclosure, unless otherwise expressly specified and limited, the first feature “above” or “below” the second feature may mean that the first feature and the second feature contact directly, or the first feature and the second feature contact indirectly through the intermediate medium. Moreover, the first feature “over”, “above” and “upwards” the second feature may mean that the first feature is directly above or obliquely above the second feature, or simply indicate that the first feature is higher in level than the second feature. The first feature “downwards”, “under”, and “below” the second feature may mean that the first feature is directly below or obliquely below the second feature, or simply indicate that the first feature is less in level than the second feature.

Term definition are as follows.

Sound pressure level (SPL) chart of a headset: a graph showing a relationship between the SPL and a frequency of the headset. The SPL is a measure of sound intensity, which is expressed in decibels (dB) and describes the amount of sound the headset can produce under a certain condition.

Frequency response (FR) curve: it may reflect conversion efficiency of converting electrical energy into sound vibration by an electroacoustic device; and it is received by a microphone built into an artificial ear or head and torso simulator and is presented in a form of dB/SPL on the chart, wherein a test is usually performed by a microphone with a frequency response range of 20 -20 KHz.

Harman over-ear 2018 (Harman OE 2018) is a headset frequency response curve developed by Harman International Industries to optimize the hearing experience of a headset. The curve is based on a large number of listening test data and subjective hearing perception surveys, reflecting the preference of most users for ideal sounds, and applies to most music types and users. The Harman OE 2018 frequency response curve is widely used in a headset design and tuning process, and many headset manufacturers use the curve as a reference to design headset products that meet the listening preferences of the public, with a goal of achieving natural and balanced sound quality, so that users are not tired when listening for a long period of time.

Harman over-ear Linear 2018 (Harman OE Linear 2018) is another frequency response curve proposed by a Harman Research team based on the Harman OE 2018. Unlike the Harman OE 2018 which is designed to conform to subjective listening preferences, the Harman OE Linear 2018 focuses more on a linear response, with a goal of minimizing audio distortion as much as possible and providing accurate, realistic sound reproduction, which best conforms to a head-related transfer function (HRTF).

HRTF is a function that describes a transmission path of sound from a sound source to an auditory canal of a listener. It comprehensively considers influence of an auricle, a head, a shoulder and an external auditory canal, reflecting the characteristics of a spatial orientation and directionality. In the headset, a relationship between the HRTF and the FR curve can be understood as that the closer the frequency response curve FR of the headset is to the HRTF, the more accurate and original the sound of the headset is. A target response is a frequency response curve of the headset under an ideal condition, or an international standard headset curve.

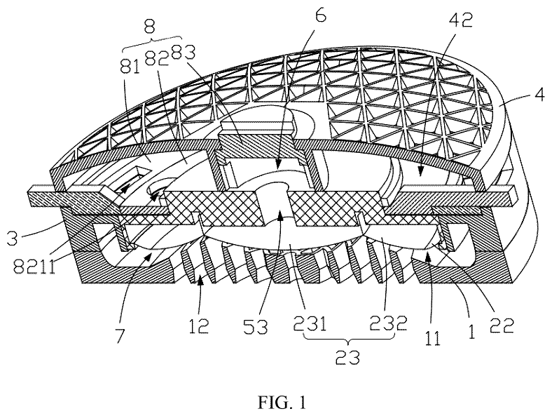

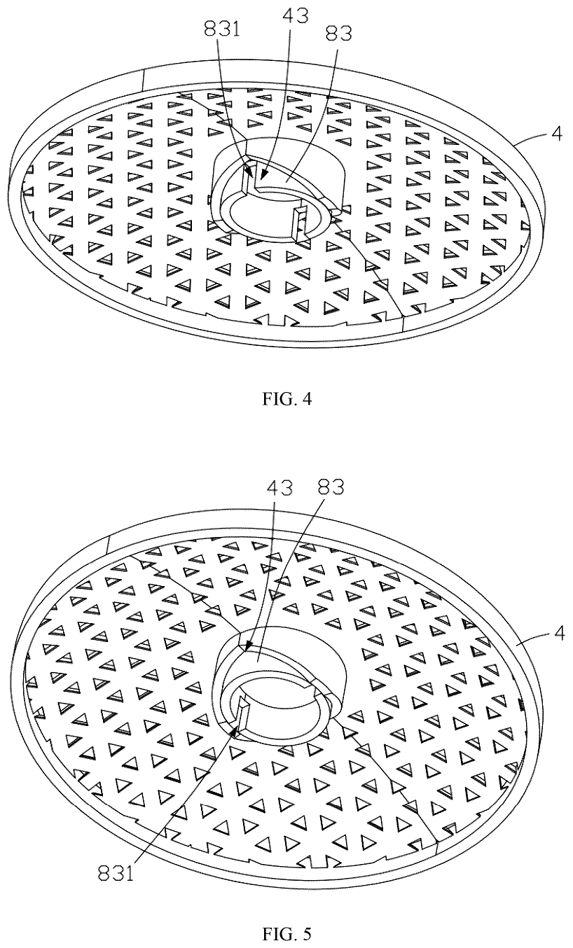

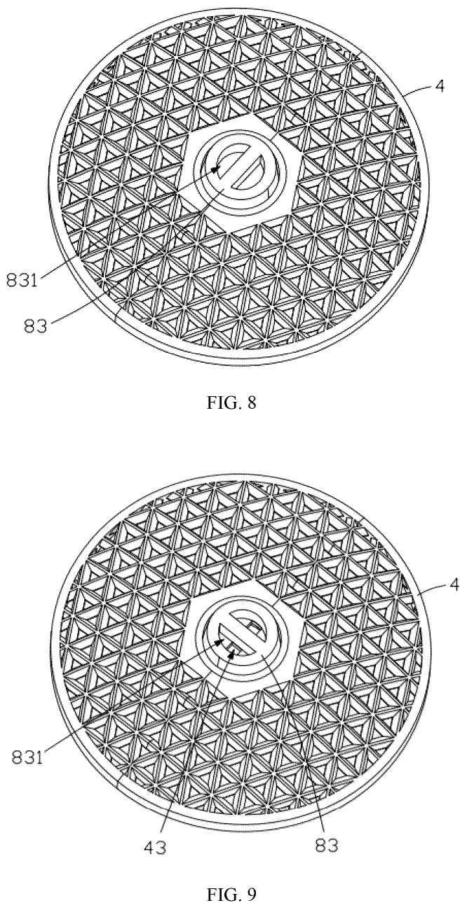

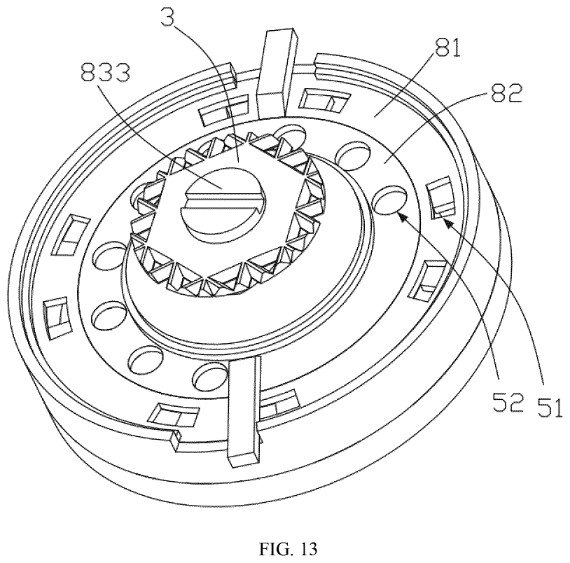

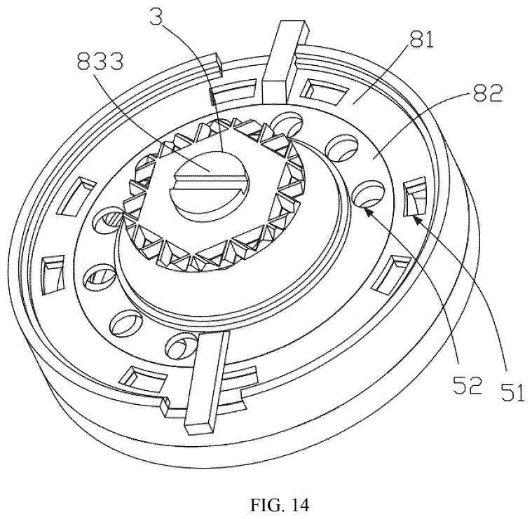

The technical solutions of this disclosure are further elaborated and explained in combination with the attached FIG. 1 to FIG. 21 and specific embodiments.

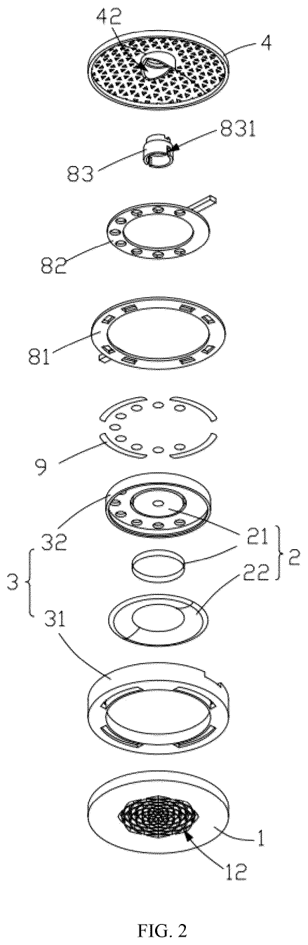

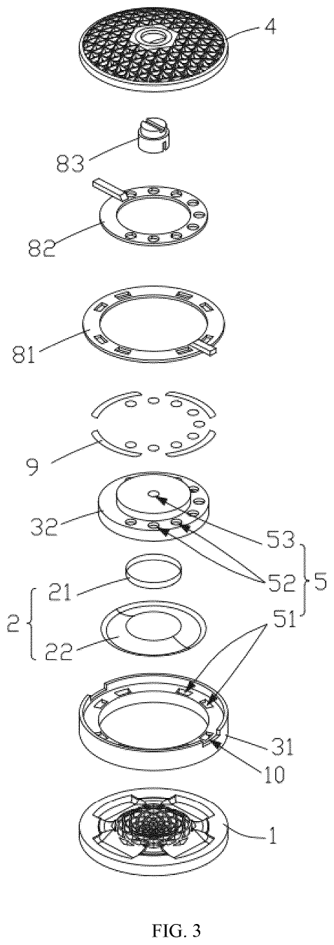

In particular, as shown in FIG. 1, FIG. 2 and FIG. 3, a tuning headset body provided in the present disclosure includes a front housing 1, a sounding unit 2, a suspension frame 3 and a rear housing 4. The front housing 1, the suspension frame 3, and the rear housing 4 are stacked in a front and back direction, that is, the suspension frame 3 is located between the front housing 1 and rear housing 4. It should be noted that a connection mode between the suspension frame 3 and the front housing 1 and the rear housing 4 is not limited, for example, they may be connected by clamping, integrated forming, a bolted connection, 3D printing molding. In this embodiment, the sounding unit 2 is mounted on the suspension frame 3. The front may be understood as one side close to a wearer, and the rear may be understood as one side away from the wearer.

The front housing 1 and the rear housing 4 are joined to form an accommodation space inside the headset body, and the front housing 1 and the rear housing 4 may be designed in a split type. The suspension frame 3 divides the internal space of the tuning headset body into a tuning cavity 6 and a rear sound cavity 42, and the suspension frame 3 is provided with a sound-transmitting channel 5 to communicate the tuning cavity 6 and the rear sound cavity 42, wherein the tuning headset body further includes a tuning assembly 8, and the tuning assembly 8 is configured to control a degree of closure of the sound-transmitting channel 5 to adjust air flow resistance at a corresponding position.

The suspension frame 3 is arranged to isolate front and rear sound waves emitted by the sounding unit 2, thus reducing occurrence of complete “acoustic short circuit”. The “acoustic short circuit” may be understood as the front and back sound waves emitted by the sounding unit 2 are not effectively isolated, and the front and back sound waves would cancel each other, resulting in a weakened sound effect. A frequency and frequency response range of sound can be adjusted by using the feature of the “acoustic short circuit”.

Therefore, by arranging the tuning assembly 8 and using physical means to control the degree of closure of sound-transmitting channel 5, air flow resistance among the tuning cavity 6, the rear sound cavity 42 and the external may be adjusted, that is, a degree of the “acoustic short circuit” may be controlled, and then a frequency band of the radio is adjusted to achieve effective adjustment of a sound field, the frequency response range, high, middle and low frequency bands, timbre and sound insulation effect, so as to expand the headset body to adapt to a listening music type and a use scenario. This product does not need to be tuned electronically to reduce loss of acoustic performance, that is, to reduce distortion during a sound production process of a headset.

In an embodiment of this disclosure, referring to FIG. 2 to FIG. 5, the rear housing 4 is extended into the headset body with a ring wall to form a tuning channel 6, wherein the ring wall is located in a center of the headset body; and in the rear sound cavity 42, the tuning channel 6 is communicated with the sound-transmitting channel 5.

The tuning assembly 8 includes a tuning valve 83, wherein the tuning valve 83 is arranged inside the tuning channel 6. The tuning valve 83 may either be located completely inside the tuning channel 6, or the top of the tuning valve 83 extend to the outside of the rear housing 4, so that a user may control the tuning valve 83. The tuning valve 83 is configured to control the degree of closure of the sound-transmitting channel 5 corresponding to the tuning channel 6 to adjust corresponding air flow resistance.

In an embodiment of this disclosure, the tuning valve 83 is provided with a hollow portion 831, and the tuning valve 83 is capable of moving relative to the rear housing 4 to adjust the degree of closure of the corresponding sound-transmitting channel 5. Alternatively, the hollow portion 831 is a slot structure, and sound waves may pass through the hollow portion 831. Alternatively, a adjusting knob 833 is provided at one end of the tuning valve 83 away from the sounding unit 2. A screw position of the tuning valve 83 is controlled by screwing the adjusting knob 833.

Please refers to FIG. 3 to FIG. 9, in an embodiment of the present disclosure, the rear housing 4 is provided with a matching part 43 matched with the hollow portion 831, and the tuning valve 83 is rotationally connected to the rear housing 4 to adjust an overlap degree between the hollow portion 831 and the matching part 43, so as to control the degree of closure of the corresponding sound-transmitting channel 5. Alternatively, the mating part 43 is a slot structure, and when the mating part 43 and the hollow portion 831 coincide, the sound waves may pass through the hollow portion 831 and the mating part 43.

By screwing the tuning valve 83, a relative position of the hollow portion 831 and the matching part 43 may be controlled, and then an overlap degree of the hollow portion 831 and the matching part 43 may be controlled. When the overlap degree of the hollow portion 831 and the matching part 43 increases, the degree of closure of the sound-transmitting channel 5 correspondingly decreases. In other words, the air flow resistance would become smaller. On the contrary, when the overlap degree of the hollow portion 831 and the matching part 43 becomes smaller, the degree of closure of the sound-transmitting channel 5 correspondingly increases. In other words, the air flow resistance would increase.

The tuning valve 83 may be rotated to infinitely adjust the degree of closure of the hollow portion 831 from being full-opened to being full-closed, so as to change the air flow resistance inside and outside the tuning valve 83, and to adjust and control the sound characteristics of audio of the headset body.

Please refer to FIG. 3 to FIG. 5, in an embodiment of the present disclosure, the hollow portion 831 is located on one side of the tuning valve 83 close to the sounding unit 2; and the matching part 43 is arranged on one side of the rear housing 4 close to the sounding unit 2 so that the tuning channel 6 is in communication with the rear sound cavity 42.

When the overlap degree between the matching part 43 and the hollow portion 831 increases, air flow resistance of the hollow portion 831 becomes smaller. Preferably, a top-closed screwing part 833 is provided. Optionally, the screwing part 833 is a groove suitable for tool screwing, or a mechanical or an electrically controlled rotary knob or a key.

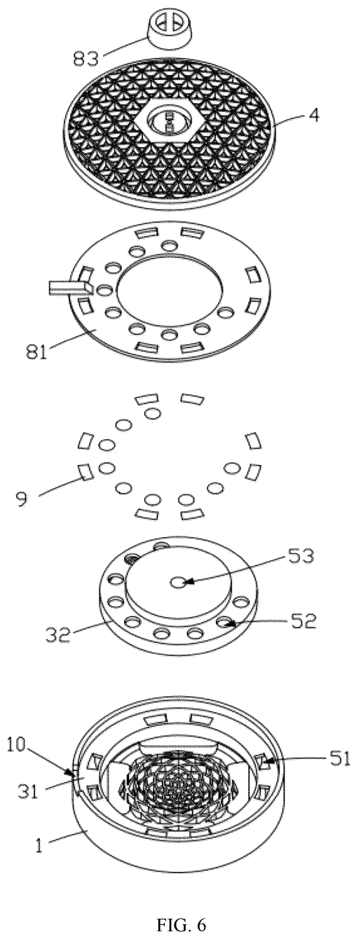

Refer to FIG. 6 to FIG. 9, in another embodiment of the present disclosure, the hollow portion 831 penetrates through the tuning valve 83 along a front and back direction, and the matching part 43 penetrates through the rear housing 4 along a front and back direction.

When the overlap degree between the matching part 43 and the hollow portion 831 increases, air flow resistance of the hollow portion 831 becomes smaller.

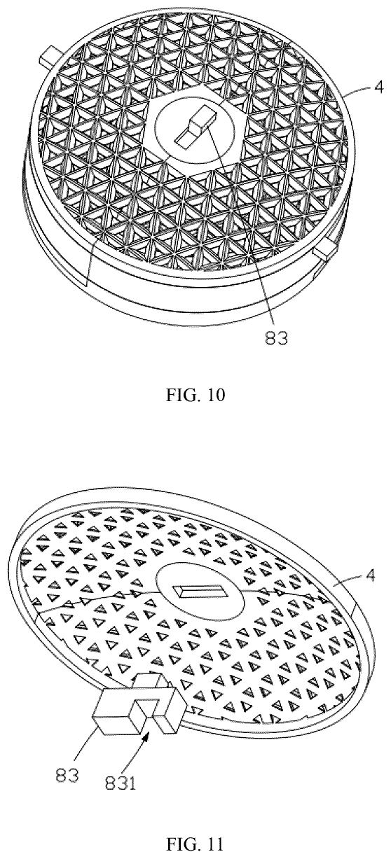

Refer to FIG. 10 and FIG. 11, in a still another embodiment of the present disclosure, a movement mode between the tuning valve 83 and the rear housing 4 is: the tuning valve 83 is slidably connected to the rear housing 4, and the hollow portion 831 is located in the tuning channel 6 and adjacent to the corresponding sound-transmitting channel 5.

When a position of the hollow portion 831 is directly aligned with the corresponding sound-transmitting channel 5, the sound waves may pass through the hollow portion 831. The overlap degree between the hollow portion 831 and the corresponding sound-transmitting channel 5 is controlled by sliding the tuning valve 83.

In an embodiment of the present disclosure, refer to FIG. 2 and FIG. 3 again, the sounding unit 2 includes a transducing assembly 21 and a diaphragm 22, and the diaphragm 22 is fixedly connected at one side of the suspension frame 3 facing the front housing 1. In particular, the diaphragm 22 includes a first tuning diaphragm cavity 231 and a second tuning diaphragm cavity 232, wherein a position of the first tuning diaphragm cavity 231 corresponds to an outer perimeter of the suspension frame 3, and a position of the second tuning diaphragm cavity 232 corresponds to a center of the suspension frame 3.

The first tuning diaphragm cavity 231 and the second tuning diaphragm cavity 232 are arc-shaped protrusion towards the tuning cavity 6 and constitute a sounding space communicated with the sound-transmitting channel 5 of the suspension frame 3 respectively. A pressure wave generated by vibration of the diaphragm 22 matches a frequency of an original sound signal and is transmitted to a human ear for analysis. The sounding space not only provides a vibration space for the diaphragm 22, but also adapts to the sound-transmitting channel 5 to form a sound channel communicating the tuning cavity 6 with the rear sound cavity 42, and further passes through the second tuning diaphragm cavity 232 and the tuning valve 83 arranged in a corresponding center of the suspension frame 3, so as to form a tuning space with adjustable opening with respect to the rear sound cavity 42 and the external environment.

In an embodiment of the present disclosure, the sounding unit 2 adopts a combination of moving iron and moving coil sounding modes, and the transducing assembly 21 is a coil and a magnet. Alternatively, the transducing assembly 21 is one or more of a coil, a magnet, a piezoelectric element, an electrostatic element to match performance of different headset bodies. As another embodiment, a planar diaphragm 22 may also be selected as a special type of drive unit of the headset body, and the headset body with the planar diaphragm 22 may generally provide a sound feedback having low distortion, a high resolution, and a broad frequency response, which is suitable for a high-fidelity audio application.

In particular, the planar diaphragm 22 is usually made of a lightweight but rigid material such as polyimide film or aluminum, the diaphragm 22 is covered with a conductive material, and a magnet is arranged on both sides of or around the diaphragm 22, wherein the conductive material is responsible for converting an electrical signal into mechanical vibration of the diaphragm 22, and the magnet is used to generate a stable magnetic field.

In an embodiment of the present disclosure, refer to FIG. 1 to FIG. 3, a center of the front housing 1 is provided with a through hole area 12, and a vibration sound guiding isthmus 7 is formed between the through hole area 12 and the diaphragm 22, which is used to preserve a certain vibration space of the diaphragm 22 and transducing assembly 21 in the front housing 1, so that a segmentation vibration phenomenon of the transducing assembly 21 is relatively minimized in vibration of different frequencies. Therefore, smoothing of an overall sound frequency domain curve is improved while overall harmonic resonance distortion is reduced.

In an embodiment of the present disclosure, refer to FIG. 2 and FIG. 3, the suspension frame 3 includes a main suspension frame 31 and a transducer suspension frame 32, and the sound-transmitting channel 5 includes a plurality of first sound-transmitting holes 51, a plurality of second sound-transmitting holes 52 and a plurality of third sound-transmitting hole 53, wherein the plurality of first sound-transmitting holes 51 are arranged in the main suspension frame 31 and arranged coaxially at intervals. The plurality of second sound-transmitting holes 52 are arranged in the transducer suspension frame 32 and arranged coaxially at intervals. The third sound-transmitting hole 53 are arranged in a center of the suspension frame 3 corresponding to the sounding unit 2, i.e. the main suspension frame31. The first sound-transmitting holes 51, the second sound-transmitting holes 52 and the third sound-transmitting hole 53 are capable of communicating the tuning cavity 6 with the rear sound cavity 42, and the tuning assembly 8 is configured to adjust degree of closure of the first sound-transmitting holes 51, the second sound-transmitting holes 52 and the third sound-transmitting hole 53.

It should be understood that the first sound-transmitting holes 51, the second sound-transmitting holes 52, and the third sound-transmitting hole 53 may be arranged in a circular, or symmetrical or irregular arrangement to form a plurality of through holes of which the number may be such as 8, 9. In some other embodiments, the through holes of the first sound-transmitting holes 51, the second sound-transmitting holes 52 and the third sound-transmitting hole 53 may be set in a shape, such as a square, a circle, or an oval, which is not specifically limited in the present disclosure.

A plurality of sound paths are formed in the front and rear cavities 42 by setting the first sound-transmitting holes 51, the second sound-transmitting holes 52 and the third sound-transmitting hole 53.

Specifically, positions of the third sound-transmitting hole 53 are directly opposite a position of the tuning channel 6, and the tuning valve 83 is used to adjust the degree of closure of the third sound-transmitting hole 53.

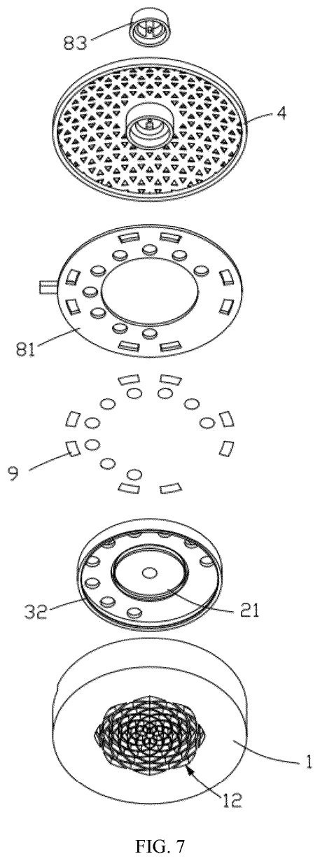

Alternatively, refer to FIG. 2 and FIG. 3, the main suspension frame 31 and the transducer suspension frame 32 are arranged as separate concentric rings, or they may be arranged as one piece by reference to FIG. 6 and FIG. 7. The size, spacing and position of sound-transmitting channel 5 can be set according to tuning needs of the headset body.

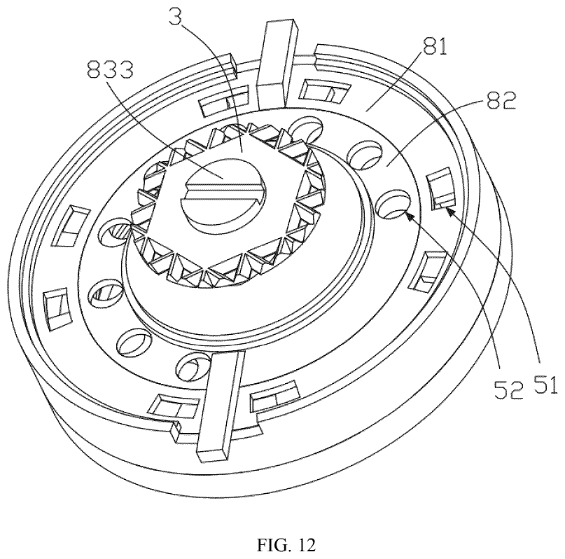

In an embodiment of the present disclosure, refer to FIG. 12 to FIG. 15, the tuning assembly 8 includes a first valve plates 81 and a second valve plates 82. The first valve plate 81 is corresponded to the first sound-transmitting hole 51, and the second valve plate 82 is corresponded to the second sound-transmitting hole 52. The first valve plate 81 and the second valve plate 82 have the same structure.

In specification, the first valve plate 81 is rotationally provided on the main suspension frame 31 to control the degree of closure of the first sound-transmitting holes 51. The second valve plate 82 may rotationally provide on the transducer suspension frame 32 to control the degree of closure of the second sound-transmitting holes 52. The acoustic characteristics of the sound are adjusted through coordinated adjustment of a sound propagation path between the tuning cavity 6 and the rear sound cavity 42 by the first valve plates 81, second valve plate 82 and the tuning valve 83.

It should be noted that the tuning valve 83, the first valve plate and the second valve plate 82 may be adjusted separately, that is, the tuning assembly 8 may include one or more of the tuning valve 83, the first valve plate 81 and the second valve plate 82. Or the tuning assembly 8 may include the tuning valve 83 and the first valve plate 81. Or the tuning assembly 8 may include the tuning valve 83 and the second valve plate 82. Or the tuning assembly 8 may include the tuning valve 83, the first valve plate 81 and the second valve plate 82.

That is The number of valve plates is not limited to two, but may also be only one. When the number of valve plate is one, it may only be configured to adjust the degree of closure of the first sound-transmitting holes 51 or the second sound-transmitting holes 52, or a size of the valve plate 81 may be increased to adjust the degree of closure of the first sound-transmitting holes 51 and the second sound-transmitting holes 52 at the same time (as shown in FIG. 6 and FIG. 7).

That is, it is possible to adjust only one of the tuning valve 83, the first valve plate 81 corresponding to the first sound-transmitting holes 51, or the second valve plate 82 corresponding to the second sound-transmitting holes 52, or two of them, or a combination of the three to realize adjustment of the frequency band of the radio, so as to achieve effective adjustment of the sound field, frequency response range, high, middle and low frequency bands, timbre and sound insulation effect. Therefore, the headset body is expanded to adapt to a listening music type and a use scenario.

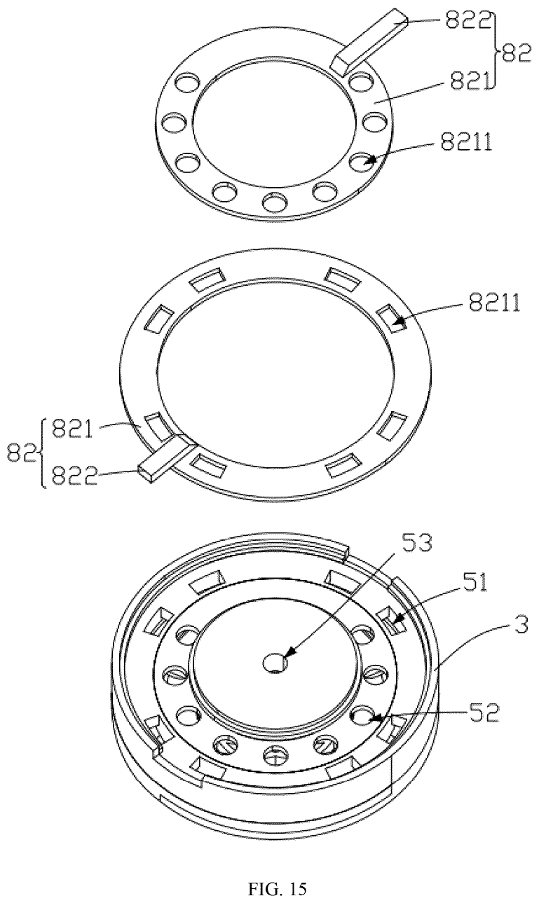

In an embodiment of the present disclosure, refer to FIG. 15, the second valve plate 82 includes a baffle plate 821 and a adjusting part 822, wherein the baffle plate 821 is defined with a plurality of through holes 8211, and the plurality of through holes 8211 are arranged around an axis of the baffle plate 821, and positions of the through holes 8211 are correspond to positions of the first sound-transmitting holes 51 or the second sound-transmitting holes 52 in position, so as to control the degree of closure of the first sound-transmitting holes 51 or the second sound-transmitting holes 52 by rotating the baffle plate 821. The adjusting part 822 is connected to the baffle plate 821 and at least partially exposed outside the suspension frame 3.

Alternatively, the adjusting part 822 is an adjusting rod, and the adjusting rod is extended outside the headset body, and the adjusting rod is moved within a range of a relief hole 10 provided in the main suspension frame 31. A user may control relative movement of the baffle plate 821 inside the headset body relative to the first sound-transmitting holes 51 and the second sound-transmitting holes 52 by moving the adjusting rod outside the headset body and complete infinite adjustment of the degree of closure of the first sound-transmitting holes 51 and the second sound-transmitting holes 52 through the baffle plate 821.

In other embodiments, the headset body may also control rotation of the first valve plate 81 or the second valve plate 82 by a rotary knob or key arranged outside the rear housing 4. This process may be achieved mechanically or electrically, and the number of the valve plates 81, adjusting rods, buttons or keys may be selected as required.

In an embodiment of the present disclosure, refer to FIG. 2 and FIG. 3, the first sound-transmitting holes 51, the second sound-transmitting holes 52 arranged in the suspension frame 3 and the third sound-transmitting hole 53 arranged in a center of the suspension frame are all provided with a tuning damping piece 9 for dust prevention of the headset body and internal dust prevention of the transducing assembly 21, while providing certain air flow resistance for the tuning of the headset body. Alternatively, the tuning damping piece 9 is tuning cotton or tuning paper.

A plurality of sound-transmitting paths are arranged between the tuning cavity 6 and the rear sound cavity 42 and the tuning assembly 8 is arranged accordingly, which are used to control the air flow resistance among the tuning cavity 6, the rear sound cavity 42 and the external environment. When the tuning valve 83 is rotated, it is equivalent to directly adjusting the air flow resistance among the tuning cavity 6, the rear sound cavity 42 and the external environment. By controlling the tuning valve 83, the sound characteristics can be changed sensitively and effectively in a manner of adjusting the air flow resistance, and the sound field, frequency response range, high, middle and low frequency bands, timbre and sound insulation effect of the headset body may be adjusted in combination with the control of the degree of closure of the sound-transmitting channel 5.

To further illustrate the sound performance of the tuning headset body provided in this disclosure, the inventor conducts the following tests.

(1) The tuning valve 83 is full-opened/half-opened/full-closed; and the valve plate 81 and the second valve plate 82 are half-opened, that is, the first sound-transmitting holes 51 and the second sound-transmitting holes 52 are half-closed.

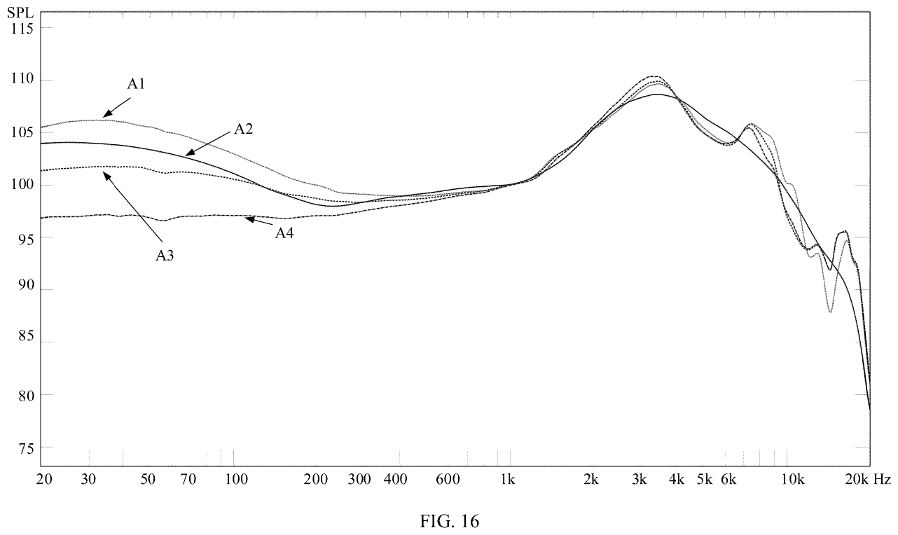

In FIG. 16, curve A1 represents a state of first sound-transmitting hole 51 half-opened+second sound-transmitting hole 52 half-opened+third sound-transmitting hole 53 full-opened; curve A2 represents Harman over-ear curve; and curve A3 represents a state of first sound-transmitting hole 51 half-opened+second sound-transmitting hole 52 half-opened+third sound-transmitting hole 53 half-opened; and curve A4 represents a state of first sound-transmitting hole 51 half-opened+second sound-transmitting hole 52 half-opened+third sound-transmitting hole 53 full-closed.

The degree of closure of the third sound-transmitting hole 53 is adjusted by tuning valve 83. It can be seen from FIG. 16 that the degree of closure of the tuning hole has a great influence on the sound intensity in the low frequency band, and tuning valve 83 can effectively adjust the bass.

When the tuning valve 83 is full-opened (the tuning valve 83 is at a position of 0 degree, refers to curve A1 of FIG. 16), the third sound-transmitting hole 53 has the largest opening, that is, full opened, and a sound pressure level at 30 hz is 106 dB.

When the tuning valve 83 is half-opened (the tuning valve 83 is at a position of 45 degrees, refers to curve A3 of FIG. 16), the sound channel of the third sound-transmitting hole 53 is half-opened, and the sound pressure level at 30 hz is 102 dB.

When the tuning valve 83 is full-closed (the tuning valve 83 is at a position of 90 degrees, refers to curve A4 of FIG. 16), the third sound-transmitting hole 53 is closed, and the sound pressure level at 30 hz is 97 dB, and the sound pressure level at the bass position has a 9 dB difference when the tuning valve 83 is full-opened and full-closed, which is enough to produce 3 times of volume difference in the hearing perception. That is, may realize the effective adjustment of bass hearing perception of the headset body through the infinite adjustment of the tuning valve 83, so as to adapt to different types of music with different bass needs.

(2) The tuning valve 83 is ⅙-opened, and the first valve plate 81 and the second valve plate 82 are half-opened, that is, the first sound-transmitting holes 51 and the second sound-transmitting holes 52 are half-closed.

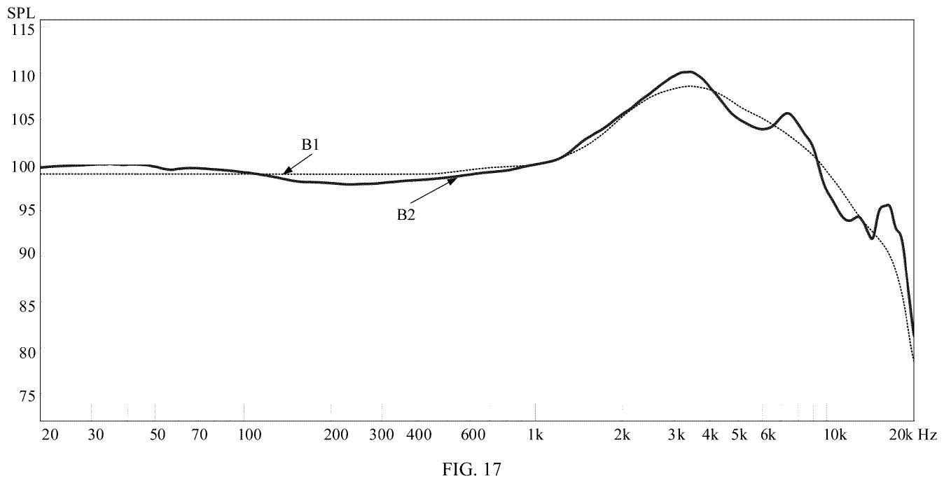

In FIG. 17, curve B2 represents a state of first sound-transmitting hole 51 half-opened+second sound-transmitting hole 52 half-opened+third sound-transmitting hole 53 opened at 25%.

As shown in FIG. 17, when the tuning valve 83 is ⅙-opened (the tuning valve 83 is at a position around 25 degrees), the frequency response curve of the headset body is very consistent with the Harman over-ear 2018 (Harman OE 2018), corresponding to curve B1 of FIG. 17. And audio of the headset body in this state is more consistent with hearing perception needs of most users and their preferences for ideal sounds and has natural and balanced sound quality, which is suitable for most types of music.

(3) The tuning valve 83 is ⅚-opened and the first valve plate 81 and the second valve plate 82 are half-opened, that is, the first sound-transmitting holes 51 and the second sound-transmitting holes 52 are half-closed

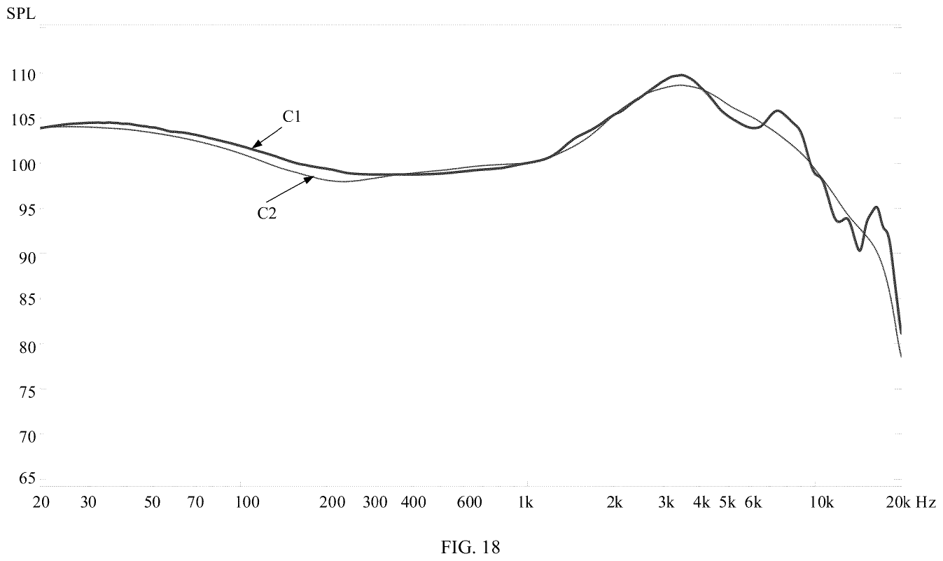

In FIG. 18, curve C1 represents a state of first sound-transmitting hole 51 half-opened+second sound-transmitting hole 52 half-opened+third sound-transmitting hole 53 open at 75%.

As shown in FIG. 18, when the tuning valve 83 is ⅚-opened (the tuning valve 83 is at a position around 75 degrees, corresponding to curve C1 of FIG. 18), the frequency response curve of the headset body is very consistent with the Harman OE Linear 2018 (Corresponding to curve C2 of FIG. 18). In this state, the audio of the headset body can reduce audio distortion as much as possible, provide accurate and true sound restoration, and capture more sound details in the music.

(4) The second valve plate 82 of a transducer is full-opened/half-opened/full-closed.

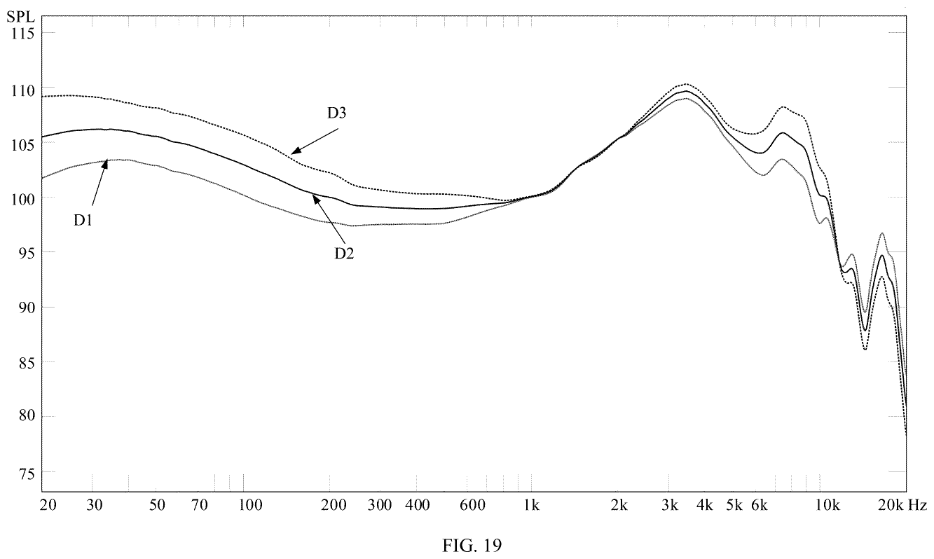

In FIG. 19, curve D1 represents a state of first sound-transmitting hole 51 half-opened+second sound-transmitting hole 52 half-opened+third sound-transmitting hole 53 full-opened; and curve D2 represents a state of first sound-transmitting hole 51 half-opened+second sound-transmitting hole 52 full-opened+third sound-transmitting hole 53 full-opened; curve D3 represents a state of first sound-transmitting hole 51 half-opened+second sound-transmitting hole 52 full-closed+third sound-transmitting hole 53 full-opened.

As shown in FIG. 19, when the second valve plate 82 of the transducer is full-opened, the degree of closure of the second sound-transmitting channel 52 is the smallest, that is, the second sound-transmitting channel 52 is full-opened, the corresponding frequency response curve (curve D1 of FIG. 19) tends to be gentle.

When the second valve plate 82 of the transducer is half-opened, the degree of closure of the second sound-transmitting channel 52 is half-opened, that is, the second sound-transmitting channel 52 is half-opened, the low-frequency and high-frequency of the corresponding frequency response curve (curve D2 of FIG. 19) are slightly elevated compared to the fully open state of the second valve plate 82.

When the second valve plate 82 of the transducer is full-opened, the degree of closure of the second sound-transmitting channel 52 is the smallest, that is, the second sound-transmitting channel 52 is full-opened. And the frequency response curve of the headset body is significantly closer to U-shaped deformation (curve D3 of FIG. 19), significant enhancement in low and high frequencies.

That is, in the present disclosure, the degree of closure of the secondsound-transmitting channel 52 is controlled by infinite adjustment of the second valve plate 82, so as to realize the effective adjustment of outputs of the high and low frequencies of the headset body at the same time. Therefore, the timbre, sound field, sound details and so on of the audio are optimized by balancing the high and low frequencies. The degree of closure of the second sound-transmitting channel 52 changes a frequency point or base point of the frequency response curve of the headset body at 1500 hz, which is mainly reflected in changes of the sounds at a low frequency below 1000 hz and a high frequency above 2000 hz.

(5) The first valve plate 81 is full-opened/half-opened/full-closed.

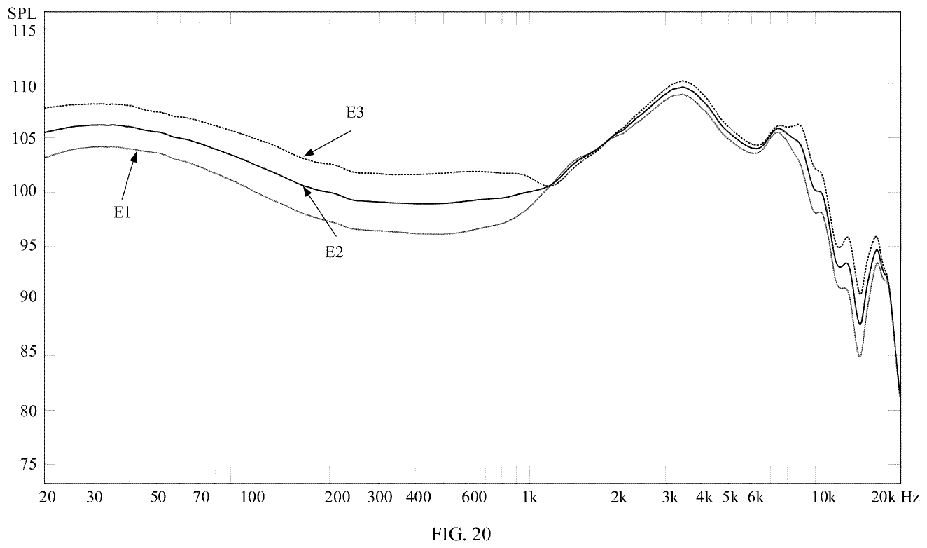

In FIG. 20, curve E1 represents a state of first sound-transmitting hole 51 full-opened+second sound-transmitting hole 52 full-opened+third sound-transmitting hole 53 full-opened; and curve E2 represents a state of first sound-transmitting hole 51 half-opened+second sound-transmitting hole 52 half-opened+third sound-transmitting hole 53 full-opened; and curve E3 represents a state of first sound-transmitting hole 51 full-closed+second sound-transmitting hole 52 full-opened+third sound-transmitting hole 53 full-opened.

As shown in FIG. 20, when the first valve plate 81 is full-opened, the degree of closure of the second sound-transmitting hole 52 is the smallest, as shown by the curve E1, which indicates that the second sound-transmitting hole 52 is in a fully opened state. The E2 curve represents that the first valve plate 81 is in a half open position, and the E3 curve represents that the first valve plate 81 is in the fully closed position.

Compareing to half-opended state and the full-opened state of the valve plate 81, the degree of closure of the first sound-transmitting channel 5 is the smallest. And the smaller the degree of closure of the first sound-transmitting hole 51, the lower the sound pressure level.

That is, in the present disclosure, the degree of closure of the first sound-transmitting channel 51 is controlled by infinite adjustment of the first valve plate 81, so as to realize the effective adjustment of the overall sound pressure level of the low-frequency output in the headset body.

It can be further seen from the figure that the adjustment of the first valve plate 81 of the main suspension frame to the middle and low frequencies is basically equivalent adjustment, and the overall sound pressure level of the middle and low frequencies may be raised or lowered in an overall and balanced manner by adjusting the first valve plate 81 of the main suspension frame, so as to optimize the timbre, sound field, sound details and so on of the audio. The degree of closure of the first sound-transmitting channel 51 of the main suspension frame 31 changes a frequency point or base point of the frequency response curve of the headset body at about 1200 hz, which is mainly reflected in changes of the sounds at a low frequency below 1200 hz.

(6) Linkage control.

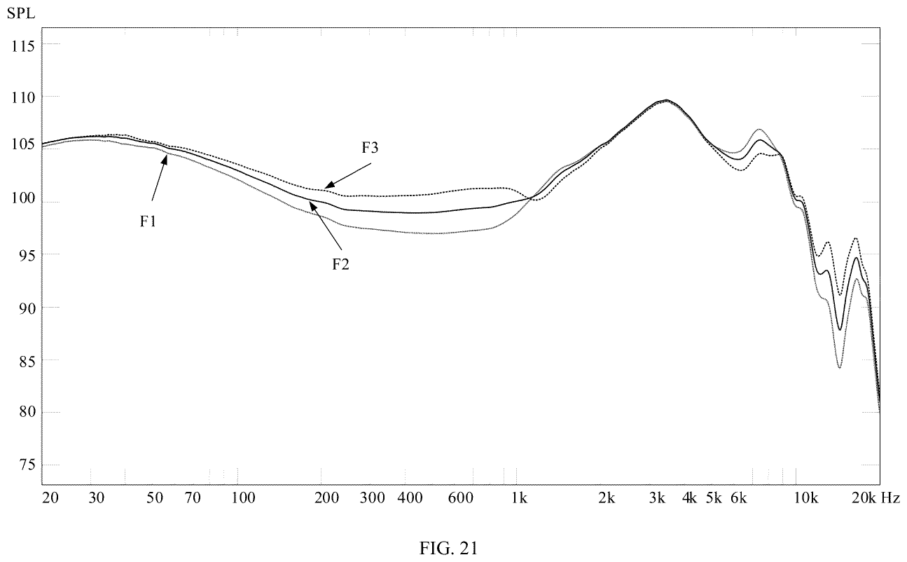

The above only lists a limited number of linkage control combinations. In fact, it can be seen in FIG. 21 that through the linkage control of the tuning valve 83, the first valve plate 81 and the second value plate 82, the valve plate of the transducer and the valve plate of the main suspension frame, the medium frequency, low frequency and high frequency intensities of the audio of the headset body and the frequency point or base point of the voice change may be adjusted multiple times, so as to change the timbre, sound field and sound details of the audio. The extension applies to different user groups and types of music.

In FIG. 21, curve F1 represents a state of first sound-transmitting hole 51 full-opened+second sound-transmitting hole 52 full-closed+third sound-transmitting hole 53 full-opened; curve F2 represents a state of first sound-transmitting hole 51 half-opened+second sound-transmitting hole 52 half-opened+third sound-transmitting hole 53 full-opened; and curve F3 represents a state of first sound-transmitting hole 51 full-closed+second sound-transmitting hole 52 full-opened+third sound-transmitting hole 53 full-opened.

Also disclosed in an embodiment of the present disclosure is a headset including a headset beam and the tuning headset body as described in any one of the above embodiments. It is to be understood that the tuning headset bodies are symmetrically arranged in two and that the two tuning headset bodies are respectively mounted on two ends of the headset beam.

The tuning headset body provided by the present disclosure is introduced above in detail, and the principle and embodiments of the present disclosure are described herein with specific examples. The illustration of the embodiments is only used to help understand a core idea of the present disclosure. Meanwhile, for general technical personnel in the field, according to the idea and methods of the present disclosure, there would be changes in a specific mode of implementation and application scope. In summary, the contents of this specification should not be understood as a limitation to the present disclosure.

What is claimed is:

1. A tuning headset body, comprising: a front housing, a rear housing, a sounding unit, a suspension frame and a tuning assembly;
wherein, the rear housing is positioned opposite the front housing; and
the sounding unit is arranged between the front housing and the rear housing; and
the suspension frame is arranged between the front housing and the rear housing; and
the sounding unit is mounted on the suspension frame;
wherein an internal space of the tuning headset body is divided into a tuning cavity and a rear sound cavity by the suspension frame; the tuning cavity comprises a front sound cavity and a tuning diaphragm cavity; and
a sound-transmitting channel is defined on the suspension frame to communicate the tuning cavity with the rear sound cavity; and
the tuning assembly is configured to control a degree of closure of the sound-transmitting channel to adjust air flow resistance.

2. The tuning headset body according to claim 1, wherein the sound-transmitting channel comprises a third sound-transmitting hole, a tuning channel is defined in the rear sound cavity of the rear housing, and the tuning channel is communicated with the third sound-transmitting hole; and
the tuning assembly comprises a tuning valve, the tuning valve is arranged in the tuning channel, and the tuning valve is configured to control a degree of closure of the third sound-transmitting hole, and to adjust air flow resistance.

3. The tuning headset body according to claim 1, wherein the suspension frame comprises a main suspension frame and a transducer suspension frame; and
the sound-transmitting channel comprises first sound-transmitting holes andsecond sound-transmitting holes;
wherein the first sound-transmitting holes are arranged in the main suspension frame and arranged coaxially at intervals; and
the second sound-transmitting holes are arranged in the transducer suspension frame and arranged coaxially at intervals; and
wherein the first sound-transmitting holes and the second sound-transmitting holes are communicated with the tuning cavity and the rear sound cavity; and
the tuning assembly is configured to adjust degrees of closure the first sound-transmitting hole and the second sound-transmitting hole.

4. The tuning headset body according to claim 1, wherein the suspension frame comprises a transducer suspension frame;
wherein the sound-transmitting channel further comprises second sound-transmitting holes and a third second sound-transmitting hole;
wherein the second sound-transmitting holes are arranged in the transducer suspension frame and arranged coaxially at intervals; and
the third second sound-transmitting hole is defined on a center of the transducer suspension frame;
wherein the second sound-transmitting holes and the third sound-transmitting hole are communicated with the tuning cavity and the rear sound cavity; and
the tuning assembly is further configured to adjust to adjust degrees of closure the second sound-transmitting holes and the third sound-transmitting hole.

5. The tuning headset body according to claim 4, wherein the tuning assembly comprises a second valve plate, the second valve plate is rotationally provided on the suspension frame to control degree of closure of the second sound-transmitting holes.

6. The tuning headset body according to claim 5, wherein the second valve plate comprises a baffle plate and an adjusting part;
wherein the baffle plate is defined with through holes, and positions of the through holes are corresponded to positions of the second sound-transmitting holes to rotate the baffle plate and control the degree of closure of the second sound-transmitting holes; and
the adjusting part is connected to the baffle plate, and at least partially of the adjusting part is exposed outside the suspension frame.

7. The tuning headset body according to claim 1, wherein the suspension frame comprises a main suspension frame;
wherein the sound-transmitting channel further comprises a plurality of first sound-transmitting holes;
wherein the first sound-transmitting holes are arranged in the main suspension frame and arranged coaxially at intervals; and
wherein the first sound-transmitting holes are communicated with the tuning cavity and the rear sound cavity; and
the tuning assembly is further configured to adjust degree of closure the first sound-transmitting holes.

8. The tuning headset body according to claim 7, wherein the tuning assembly comprises a first valve plate, the first valve plate is rotationally provided on the main suspension frame, to control degree of closure of the first sound-transmitting holes.

9. The tuning headset body according to claim 7, wherein the tuning assembly further comprises a tuning value; and
the tuning channel is defined on the rear sound cavity of the rear housing; and
the tuning value is communicated to at least one of the third sound-transmitting hole;
the tuning value is located in the tuning channel, and the tuning value is configured to control degree of closure of the third sound-transmitting holes, to adjust corresponding air flow resistance.

10. The tuning headset body according to claim 9, wherein the tuning valve is defined with a hollow portion, and the tuning valve is configured to control a position of the hollow portion by moving relative to the rear housing, further to control the degree of closure of the third sound-transmitting hole.

11. The tuning headset body according to claim 10, wherein a matching part is defined on the rear housing to match with the hollow portion, and the tuning valve is rotationally connected to the rear housing, the tuning valve is configured to adjust an overlap degree between the hollow portion and the matching part, so as to control the degree of closure of the third sound-transmitting hole.

12. The tuning headset body according to claim 11, wherein the hollow portion is located on a side of the tuning valve close to the sounding unit; and the matching part is arranged on a side of the rear housing close to the sounding unit, to connect the tuning channel and the rear sound cavity.

13. The tuning headset body according to claim 12, wherein the tuning valve is penetrated through by the hollow portion, and the rear housing is penetrated through by the matching part; and
when the overlap degree between the matching part and the hollow portion increases, the air flow resistance of the hollow portion becomes smaller.

14. The tuning headset body according to claim 10, wherein the tuning valve is slidably connected to the rear housing, and the hollow portion is located in the tuning channel and adjacent to the third sound-transmitting hole.

15. The tuning headset body according to claim 1, wherein tuning damping pieces are uniformly set in the sound-transmitting channel or the tuning assembly of the suspension frame.

16. The tuning headset body according to claim 1, wherein the sounding unit comprises a transducing assembly and a diaphragm, the diaphragm is fixedly connected to a side of the suspension frame away from the rear housing;
wherein the tuning diaphragm cavity comprises a first tuning diaphragm cavity and a second tuning diaphragm cavity;
the first tuning diaphragm cavity is arranged along an outer perimeter of the suspension frame; and
a center of the second tuning diaphragm cavity is located on the suspension frame.

17. The tuning headset body according to claim 16, wherein the transducing assembly is one or more of a coil, a magnet, a piezoelectric element and an electrostatic element.

18. A headset, wherein comprising a headset beam and a tuning headset body, the headset beam is connected to the tuning headset body;
wherein, the tuning headset body comprises a front housing, a rear housing, a sounding unit, a suspension frame and a tuning assembly;
wherein, the rear housing is positioned opposite the front housing; and
the sounding unit is arranged between the front housing and the rear housing; and
the suspension frame is arranged between the front housing and the rear housing; and
the sounding unit is mounted on the suspension frame;
wherein an internal space of the tuning headset body is divided into a tuning cavity and a rear sound cavity by the suspension frame; the tuning cavity comprises a front sound cavity and a tuning diaphragm cavity; and
a sound-transmitting channel is defined on the suspension frame to communicate the tuning cavity with the rear sound cavity; and
the tuning assembly is configured to control a degree of closure of the sound-transmitting channel to adjust air flow resistance.
